(19) United States
(12) Patent Application Publication
(10) Pub. No.: US 2020/0269154 A1
(43) Pub. Date: Aug. 27, 2020

(54) APPARATUS AND METHODS FOR RESIN EXTRACTION

(71) Applicant: Whister Technologies Corp., Vancouver (CA)

(72) Inventors: Daniel Erik LANTELA, Whistler (CA); Brishna Soraya KAMAL, Whistler (CA); Kelvin Kin-Wing WONG, Whistler (CA)

(21) Appl. No.: 16/647,327

(22) PCT Filed: Sep. 21, 2018
(86) PCT No.: PCT/CA2018/051197

§ 371 Date: Mar. 13, 2020

Related U.S. Application Data
(60) Provisional application No. 62/561,535, filed on Sep. 21, 2017.
(60) Provisional application No. 62/580,102, filed on Nov. 1, 2017.

(51) Int. Cl. B01D 11/02; B01D 21/28; B01F 7/00; B01F 7/16; B01F 15/00; B01D 21/00; B02C 23/36; B02C 18/10

(52) U.S. Cl. CPC B01D 11/0257; B01D 11/028; B01D 11/0265; B01D 21/283; B01F 7/00375; B02C 18/10; B01F 7/1675; B01F 15/00896; B01D 21/0012; B02C 23/36; B01F 7/00641

(57) ABSTRACT

The present disclosure provides an apparatus for extracting resin from plant material, comprising an agitation tank having an open top and an outlet at a bottom thereof, a strainer basket installed within the agitation tank, the strainer basket comprising walls constructed from a mesh material selected based on a type of plant material to be processed, and an agitator comprising a motor which turns a shaft and two impellers mounted on the shaft. The present disclosure also provides a process for extracting resin from plant material, comprising placing a quantity of plant material within a strainer basket comprising walls constructed from a mesh material, submersing the strainer basket in a tank filled with chilled water at a temperature in the range of 0-10 Celsius, agitating the plant material and chilled water within the strainer basket to separate trichomes from the plant material, and removing a mixture of water and trichomes from an outlet at the bottom of the tank.

### CROSS REFERENCE TO RELATED APPLICATIONS

This application claims the benefit of priority of U.S. Provisional Patent Application No. 62/561,535, which was filed on Sep. 21, 2017, and U.S. Provisional Patent Application No. 62/580,102, which was filed on Nov. 1, 2017, both of which are hereby incorporated herein by reference in their entireties.

### TECHNICAL FIELD

The present disclosure relates to extraction of resins from plant materials.

### BACKGROUND

Many plants concentrate resin in glandular structures called trichomes on the outside of leaves. These can be mechanically separated from the plant matter to collect the resin without the use of solvents. Various devices are known in the art for mechanically separating resins from plant materials.

For example, U.S. Pat. No. 6,158,591 to Delp discloses a method and apparatus for extracting plant resins wherein a washing chamber is filled with cold water, plant material, and ice, then an agitator (e.g. an electric mixer with stirring whisks) is used to mix the contents of the chamber to separate the resins. The resins are allowed to settle and then collected by a filter. However, the apparatus and method disclosed by Delp are not suited for high throughput resin extraction.

The inventors have determined a need for improved apparatus and methods for resin extraction.

### SUMMARY

One aspect of the present disclosure provides an apparatus for extracting resin from plant material. The apparatus comprises an agitation tank having an open top and an outlet at a bottom thereof, a strainer basket installed within the agitation tank, the strainer basket comprising walls constructed from a mesh material selected based on a type of plant material to be processed, and, an agitator comprising a motor which turns a shaft and two impellers mounted on the shaft.

The two impellers may comprise an upper impeller which urges material downwardly and a lower impeller which urges material upwardly. Alternately, the two impellers may both urge material upwardly, or both urge material downwardly. In some embodiments, the agitator may comprise an impeller configured to lacerate material.

The walls of the strainer basket may have openings with a diameter in a range of 200-230 microns. The strainer basket may comprise a plurality of baffles extending inwardly from a sidewall of the strainer basket. A side gap may separate each baffle from the sidewall, and a bottom gap may separate each baffle from a bottom wall of the strainer basket. The baffles may comprise rounded baffles each having an oval-shaped cross-section.

The strainer basket may be removeable from the agitation tank, and may comprise a plurality of mounting tabs extending outwardly from an upper rim of the strainer basket for suspending the strainer basket within the agitation tank. The strainer basket may comprise a plurality of draining tabs extending outwardly from a middle portion of the strainer basket for suspending the strainer basket partially out of the agitation tank.

Another aspect of the present disclosure provides a process for extracting resin from plant material. The process comprises placing a quantity of plant material within a strainer basket comprising walls constructed from a mesh material, submersing the strainer basket in a tank filled with chilled water at a temperature in the range of 0-10 Celsius, agitating the plant material and chilled water within the strainer basket to separate trichomes from the plant material, and, removing a mixture of water and trichomes from an outlet at the bottom of the tank. The process may further comprise providing the mixture of water and trichomes to a separator apparatus to separate the mixture into water a final product containing the trichomes and recycling the separated water back to the tank.

Another aspect of the present disclosure provides a system for extracting resin from plant material. The system comprises an agitation apparatus for receiving plant material and chilled water, the agitation apparatus configured to agitate the plant material to separate trichomes from the plant material to produce a mixture of water and trichomes, and a separator apparatus connected to receive the mixture of water and trichomes from the agitation apparatus, the vibratory separator apparatus configured to separate water from the mixture to produce a final product containing the trichomes. The separator apparatus may comprise a vibratory separator apparatus, or may comprise a flow path with a plurality of in-line screens.

The agitation apparatus may comprise an agitation tank having an open top and an outlet at a bottom thereof, a strainer basket installed within the agitation tank, the strainer basket comprising walls constructed from a mesh material selected based on a type of plant material to be processed, and, an agitator comprising a motor which turns a shaft and two impellers mounted on the shaft.

The agitation apparatus may comprise a passageway having an inlet and an outlet and a plurality of abrupt changes in direction between the inlet and the outlet. The agitation apparatus may further comprise an agitation chamber, with the passageway being contained within the agitation chamber. One or more vibratory transducers may be coupled to the agitation chamber. The system may comprise a filter between the outlet of the passageway and the vibratory separator apparatus to filter plant material from the mixture of water and trichomes. The vibratory separator apparatus may be configured to separate plant material from the mixture of water and trichomes.

Further aspects of the present disclosure and details of example embodiments are set forth below.

### DRAWINGS

The following figures set forth embodiments in which like reference numerals denote like parts. Embodiments are illustrated by way of example and not by way of limitation in the accompanying figures.

FIG. 1 schematically illustrates an example agitation apparatus according to one embodiment of the present disclosure.

FIGS. 1A and 1B illustrate example material flow in the agitation apparatus of FIG. 1.

FIGS. 1C and 1D show other example impeller configurations for the agitation apparatus of FIG. 1.

FIG. 1E is a perspective view of an example agitation apparatus according to another embodiment of the present disclosure.

FIG. 1F is a side view of an example agitation apparatus according to another embodiment of the present disclosure.

FIG. 2 is a perspective view of an example agitation tank of the agitation apparatus of FIG. 1.

FIG. 2A is a side view of the tank of FIG. 2.

FIG. 3 is a perspective view of an example strainer basket of the agitation apparatus of FIG. 1.

FIG. 3A is a side view of the basket of FIG. 3.

FIG. 3B is a top view of the basket of FIG. 3.

FIG. 3C shows an example rounded baffle for use in the strainer basket of FIG. 3.

FIG. 3D is a perspective view of another example strainer basket of the agitation apparatus of FIG. 1.

FIG. 3E shows top view of a portion of the side wall of the basket of FIG. 3D.

FIG. 4 schematically illustrates an example resin extraction system according to one embodiment of the present disclosure.

FIGS. 4A and 4B show an example screening separator apparatus which may be used instead of the vibratory separator apparatus in the resin extraction system of FIG. 4.

FIG. 5 shows an example agitation apparatus configured for continuous processing of plant material according to one embodiment of the present disclosure.

FIG. 5A shows the agitation apparatus of FIG. 5 with an additional filter on the outlet for removing plant material.

### DETAILED DESCRIPTION

The following describes an improved process and apparatus to separate glandular trichomes containing plant resins from plant material using cold water. Current and existing methods for extracting plant resins mechanically using ice and water do not scale well for large commercial ventures and are often inefficient. The agitation mechanisms used (forward/reverse washing machines, or hand drills) are inefficient and reduce overall yield. The separation of water and resin is laborious and the overall processes are not of a pharmaceutical standard, especially important when separating resin material for medical purposes. The present disclosure is directed to improved systems and processes for extraction or resin, and certain embodiments use an agitator tank with an interior mesh basket, to facilitate the easy replacement of spent material in the extraction chamber with new material. Certain embodiments provide an agitation apparatus comprising a baffle and two impeller systems within the interior mesh basket to cause a full rotation of plant material within the tank, which rubs against the mesh basket, speeding the removal of trichomes from plant matter. Systems according to the present disclosure can significantly improve yields and processing times over currently available methods. As described below, in an example system, after agitation, water containing resin passes through a vibratory sifting apparatus with suitably sized mesh screens (dependent on the plant material/trichome size) to remove resin from water and unwanted debris, and the resin is collected from the vibratory sifting apparatus. Water from the vibratory sifting apparatus is collected in a catchment tank and can be pumped back into the agitator to collect resin in batches or a continuous process.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

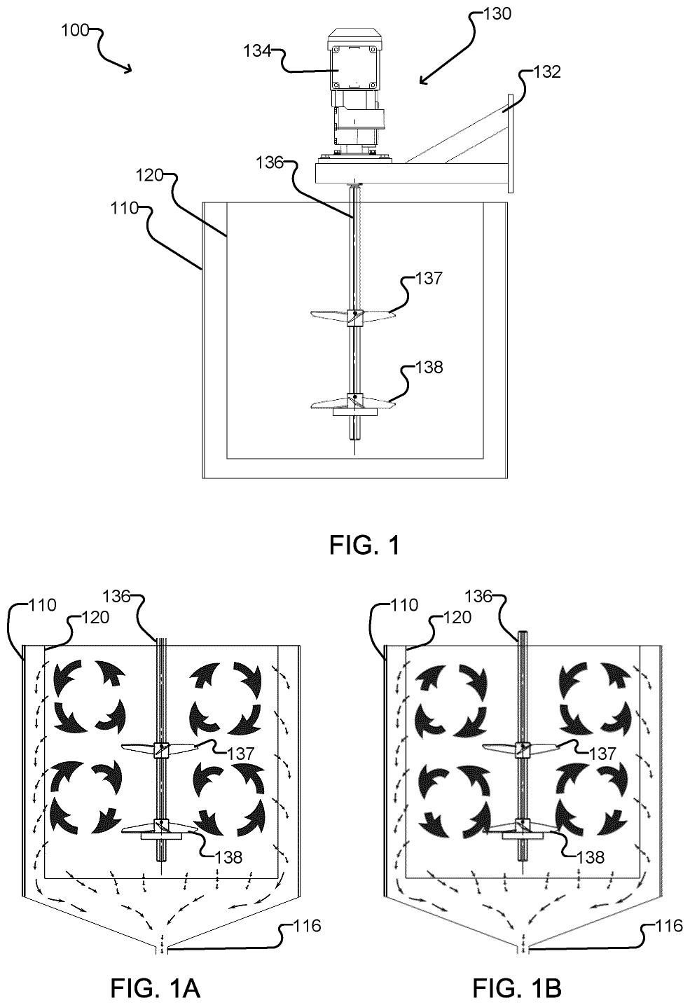

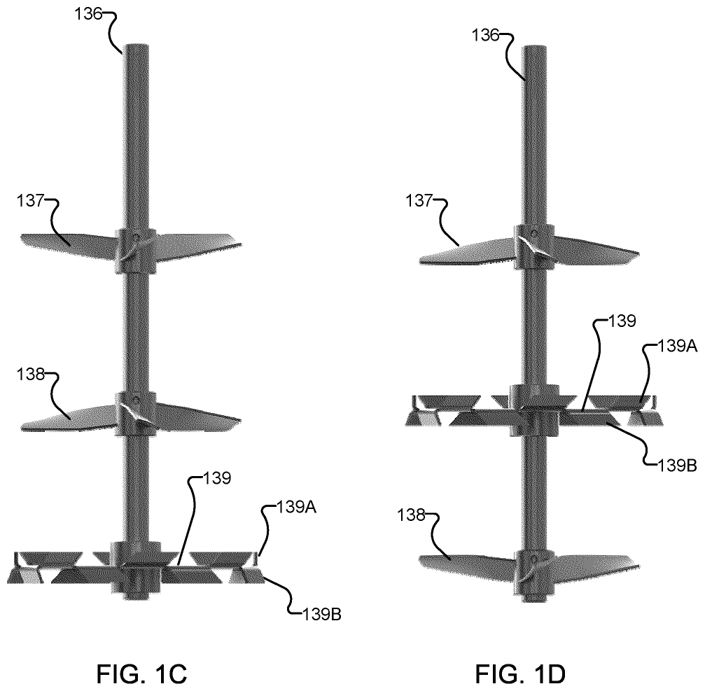

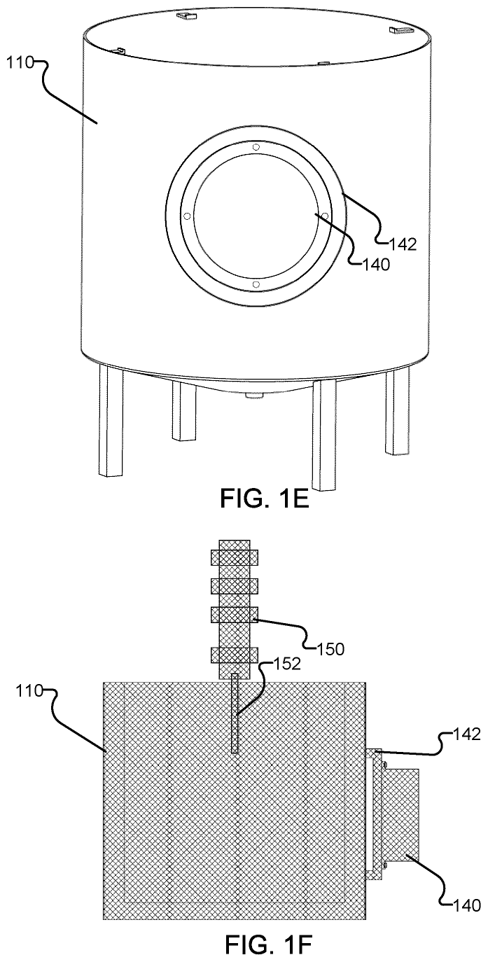

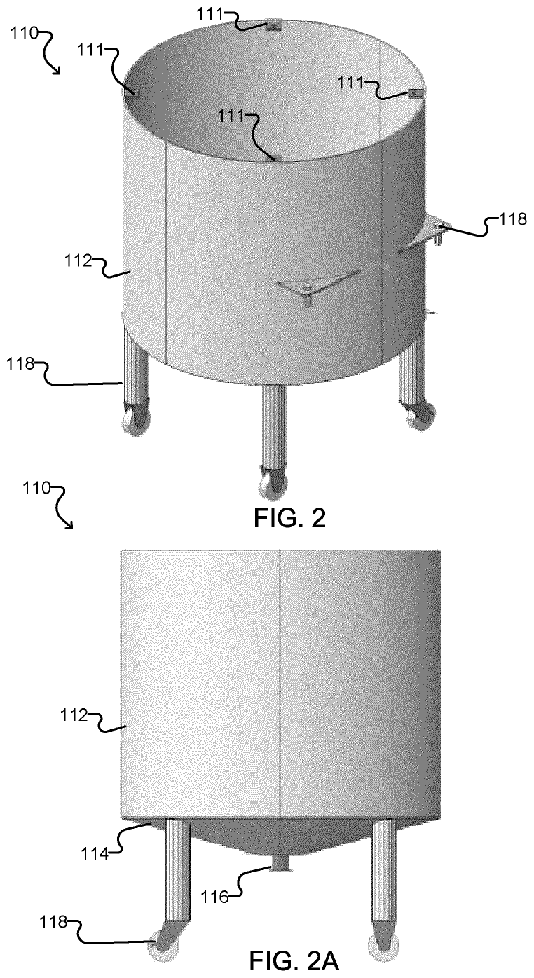

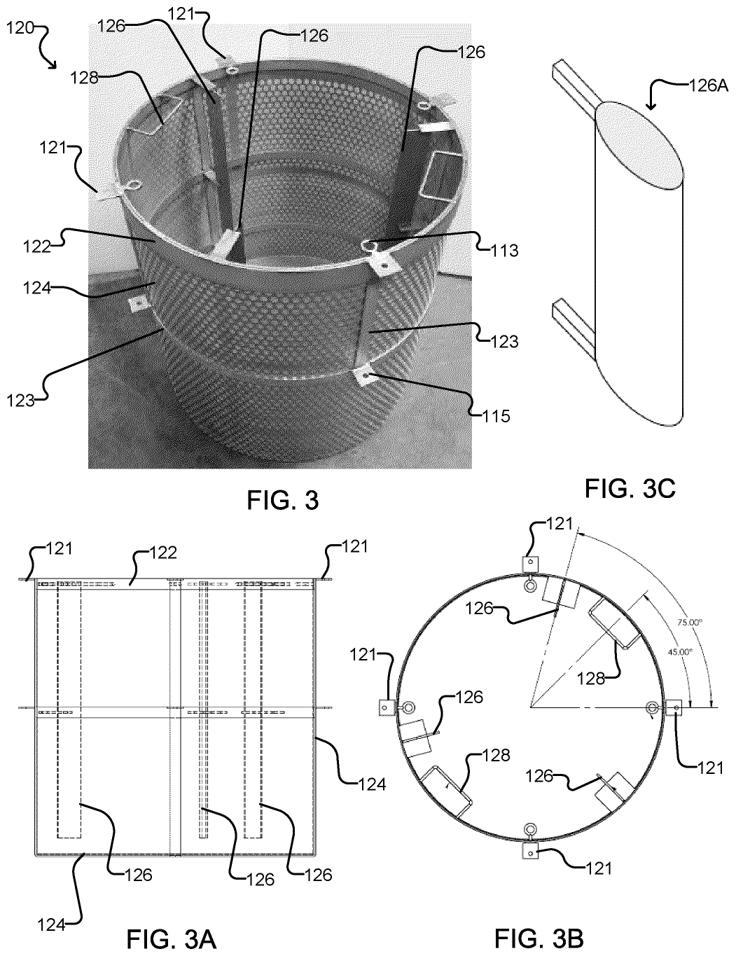

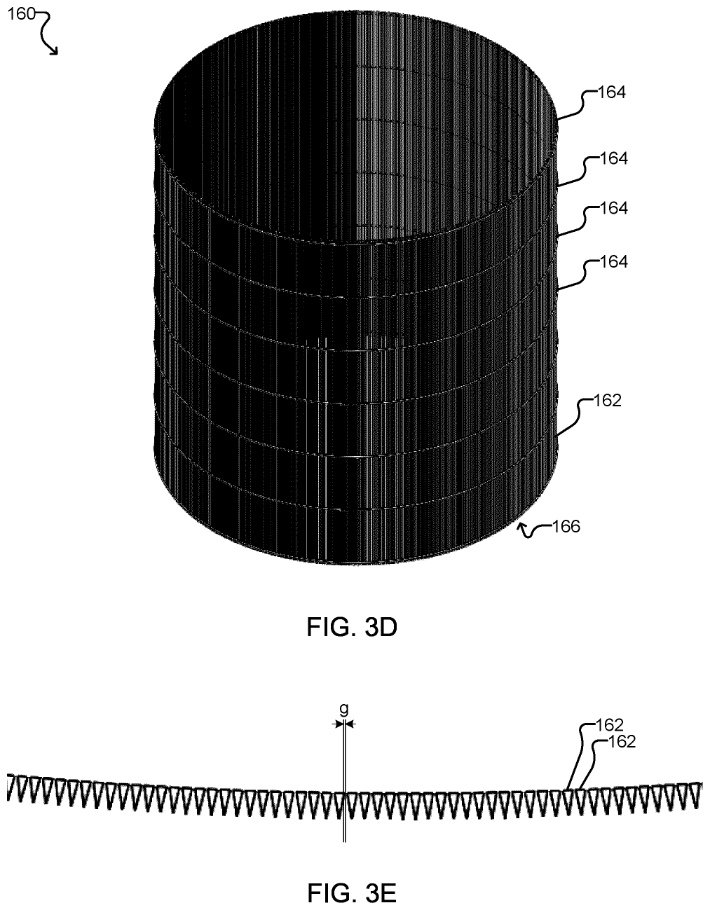

FIG. 1 shows an example agitation apparatus 100 according to one embodiment of the present disclosure. The apparatus comprises an agitation tank 110 into which is installed a strainer basket 120. The basket 120 may be filled with plant material and ice, and immersed in water within the tank to extract resins, as discussed in further detail below. Details of an example tank 110 and basket 120 are discussed below with reference to FIGS. 2-3B. An agitator 130 is provided to mix the contents of the basket 120. In the illustrated example, the agitator comprises a motor 134 mounted on a support bracket 132, which rotates a shaft 136. Two impellers 137, 138 are mounted on the shaft 136. In some embodiments, the impellers 137 and 138 are oriented in opposite directions such that when the shaft 136 rotates in a first sense (e.g. counterclockwise when viewed from above) the upper impeller 137 urges material downwardly and the lower impeller 138 urges material upwardly, and when the shaft rotates in an opposite sense (e.g. clockwise when viewed from above) the upper impeller 137 urges material upwardly the lower impeller 138 urges material downwardly. In other embodiments, the impellers 137 and 138 may be oriented in the same direction such that both urge material downward or both urge material upward.

As illustrated in FIGS. 1A and 1B, the impellers 137, 138 induce a flow of material within the basket 120 (example flows when the shaft is rotated clockwise and counterclockwise are indicated by the thick arrows in FIGS. 1A and 1B, respectively). This flow causes the plant material to be pushed against suitably sized mesh forming the sides and bottom of the basket 120, and trichomes are separated from the plant material, exit the basket 120 through the mesh (as indicated by the thin arrows in FIGS. 1A and 1B), and can be removed through an outlet 116 at the bottom of the tank 110.

In some embodiments, the agitation apparatus 100 may comprise an impeller in the form of a blade impeller 139 mounted on the shaft 136. The blade impeller 139 comprises upwardly and downwardly extending teeth 139A and 139B for lacerating the material within the basket. In some embodiments, the blade impeller is mounted on the bottom of the shaft 136, in addition to the impellers 137, 138, as shown in FIG. 1C. In some embodiments, the blade impeller is mounted on the shaft 136 between the impellers 137, 138, as shown in FIG. 1D. In some embodiments, the blade impeller 139 may take the place of the lower impeller 138. Laceration of the plant material facilitates separation of the trichomes therefrom.

The agitation apparatus 100 shown in FIG. 1 is designed for processing plant material mixed with ice to keep the contents of the tank 110 cold. In some embodiments, the use of ice may be avoided wherein the agitation tank 110 is constructed with a cooling jacket which keeps the tank 110 at a set temperature. Such embodiments allow for more precise control over the reaction temperature than is possible just using ice to cool the water and plant material.

In some embodiments, the agitation apparatus 100 may include alternate or additional agitation means than the impeller-based agitator 130 shown in FIGS. 1-1C. For example, in some embodiments, an audio wave transducer system 140 is mounted on a mounting bracket 142 attached to the exterior of the tank 110, as shown in FIGS. 1D and 1E. An audio wave transducer system 140 can be used on material from which trichomes is difficult to remove. The transducers of the audio wave transducer system 140 cause the tank 110 to vibrate as a speaker, and transmit the physical sound vibrations into the water (and surrounding air). Tuning these vibrations to a specific frequency will cause standing waves in the water within the tank 110, and the resultant vibrations cause trichome material to become separated from other plant material. In some embodiments, other types of vibratory devices may be incorporated into the agitator tank 110, or inserted into the tank as a probe can also be used to create agitation in the tank 110. These can be programmed to create different frequency waves to be propagated into extraction material. In some embodiments, sonication is employed using ultrasonic frequencies to create small scale agitation in the tank 110. FIG. 1E shows an example wherein an ultrasonic transducer 150 is coupled to an ultrasonic probe 152 configured to emit a desired frequency. In the FIG. 1E example, the probe 152 is introduced into the tank 110. In other examples the plant material may be cycled through a reaction cell containing a suitable ultrasonic probe.

In some embodiments, jets of a liquid or gas can be injected into the tank 110 of the agitation apparatus 100. Bubbles from a gas or flow streams from a liquid, such as water, will move plant material and cause the breaking of terpenes. In some embodiments, small pieces of solid material may be added to the plant material within the strainer basket 120 to facilitate agitation when mixed by an impeller. These materials would mimic the agitation caused by ice cubes in the mixture, but would not melt and allow a longer and greater and fuller agitation inside the tank versus using ice.

An example tank 110 is shown in FIGS. 2 and 2A. In the illustrated example, the tank 110 comprises inwardly extending mounting tabs 111 spaced about the open top thereof, with a cylindrical sidewall 112 and a conical bottom portion 114. The outlet 116 is located at the bottom of the bottom portion 112 of the tank 110 for removing water containing resins therefrom. Wheeled legs 118 may be provided for moving the tank 110, and mounting brackets 119 may be provided for securing the tank 110 to another structure.

An example strainer basket 120 is shown in FIGS. 3, 3A and 3B. The basket 120 comprises an upper rim 122 and additional frame elements 123 which support walls and a bottom constructed from a suitably-sized mesh 124 selected based on the type of plant material to be processed. For example, in some embodiments the mesh 124 has openings with a diameter in the range of about 200-230 microns. A plurality of outwardly extending mounting tabs 121 are spaced about the upper rim 122, and are configured to be attached to the mounting tabs 111 of the tank 110 to hold the basket 120 in place. Eyelets 113 are provided for lifting the basket 120 with an overhead lift. Draining tabs 115 allow the basket 120 to be suspended half out of the tank 110 for draining water out of the basket 120. Generally vertically oriented baffles 126 are provided extending into the interior of the basket 120 at regular intervals to interrupt circular flow or material within the basket and facilitate contact between the plant material and the mesh 124. As best seen in FIG. 3A, there is a gap between the bottoms of the baffles 126 and the bottom wall of the basket 120, and a gap between each baffle 126 and the side wall of the basket, to facilitate water flow within the basket 120. In some embodiments, instead of having generally flat baffles 126 as shown in FIGS. 3, 3A and 3B, the basket may have rounded baffles 126A with a generally oval-shaped cross section, as shown in FIG. 3C, to reduce the likelihood of plant material becoming trapped against the baffles. Handles 128 may be provided to facilitate placement and removal of the basket 120 from the tank 110. In the illustrated example, as best seen in FIG. 3B, the basket 120 comprises four mounting tabs 121 spaced at 90 degrees from each other, three baffles 126 spaced at 120 degrees from each other, and two handles 128 spaced at 180 degrees from each other.

Another example strainer basket 160 is shown in FIGS. 3D and 3E. The basket 160 comprises a plurality of vertically oriented wedge wires 162 supported by a plurality of support rings 164 around the outside of the wires 162. The bottom 166 of the basket 160 may also comprise wedge wires, or may comprise a mesh screen similar to basket 120.

In some embodiments, the bottom of the basket 120/160 comprises a hinged door to facilitate emptying of the product.

The wedge wires 162 comprise metal wires with a triangular cross section, and having a gap g between adjacent wires 162 as shown in FIG. 3E. In some embodiments the gap g is in the range of 200 to 250 microns. The wedge wires 162 act as a screen which allows trichomes to move through the gaps g. The wedge wires 162 and supporting rings 164 are advantageously stronger than a typical mesh screen, requiring less reinforcement of the basket 160. The wedge wires 162 also advantageously have less crevices than mesh screen products, which facilitates cleaning. The basket 160 may also have baffles, tabs, eyelets and/or handles similar to those of basket 120 described above. Using a pressure washer the wedge wires 162 can be easily cleaned of any plant material and resin, making the basket 160 highly sanitary.

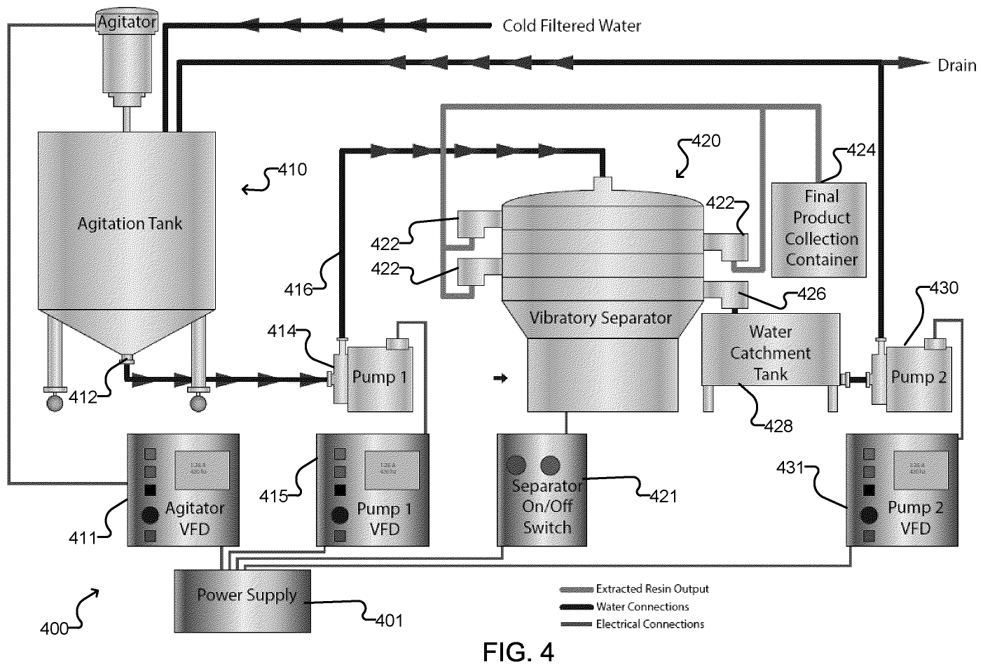

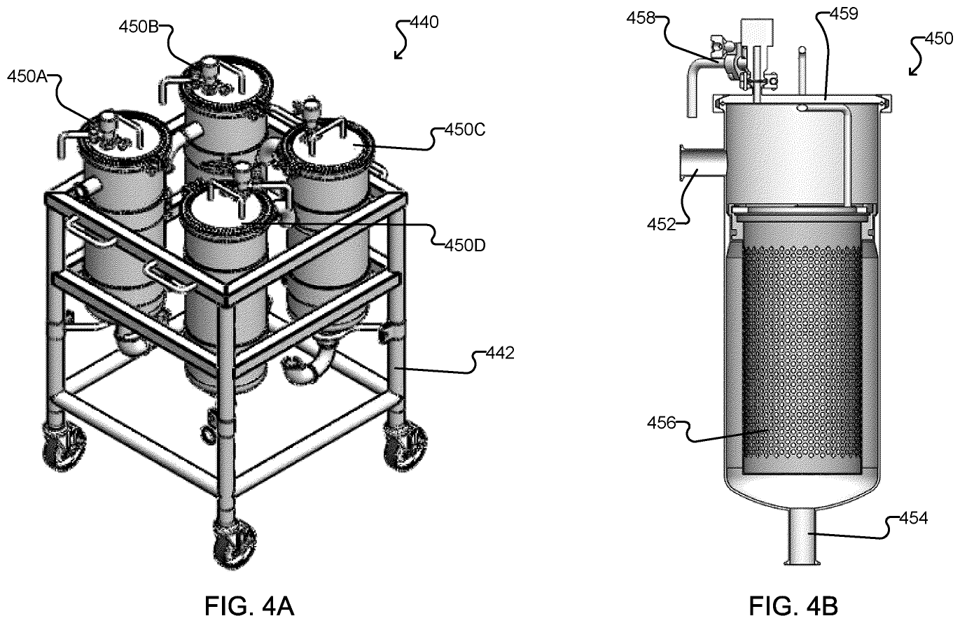

In some embodiments, water (and the resin contained therein) may be removed from the outlet 116 at the bottom of the tank 110, and drained into a gravity filter to separate water from resin as known in the art. Alternatively, in some embodiments, such as the example shown in FIG. 4, the water circulates through a vibratory sifter or other separation device, such as centrifugal filters/separators, vacuum filters or other high-throughput devices to separate particles by size. This avoids the labour requirements of separating through manual hand sieves or filters. The sifter can be operated continuously, 24 hours per day, and resin may be collect through spouts. Water separated from the resin may be collected in a tank and pumped back into the agitation apparatus. This can act in a batch wise fashion, or run continuously passing water through the agitation apparatus 100 and sifter continuously until all resin is extracted.

FIG. 4 shows an example resin extraction system 400 according to one embodiment of the present disclosure. The system 400 complies with good manufacturing practices (GMP) and all pharmaceutical grade components and is suitable for the mass extraction of plant resins destined for pharmaceutical use.

The system 400 comprises an agitation apparatus 410 (which may, for example, comprise the example apparatus 100 discussed above, or variations thereof). The outlet 412 of the agitation apparatus 410 is connected to a first pump 414. The agitation apparatus 410 and pump 414 are respectively controlled by Variable Frequency Drives (VFD) 411 and 415 connected to a power supply 401 to control their speed. The output 416 from the first pump 414 is directed to empty into the top of a vibratory separator apparatus 420 which is powered through an on/off switch 421 connected to the power supply 401. Product outlets 422 from the vibratory separator apparatus 420 are connected to a collection vessel 424 for collecting final product (resin/trichomes). The vibratory separator apparatus 420 may, for example, comprise a plurality of screens with openings of successively smaller diameters (e.g., a first screen with opening diameters in the range of 190-170 microns for catching debris, then a series of screens with opening diameters in the range of 170-30 microns (e.g. three screens with opening diameters of 120 microns, 70 microns, 40 microns) for catching resin). A water outlet 426 from the vibratory separator apparatus 420 is connected to a water catchment tank 428. The water catchment tank 428 collects the water removed from resin and has an outlet which leads into a second pump 430 controlled by another VFD 431 to recycle water back into the agitation apparatus 410 during cycling, or into the drain to dispose of water at the end of a cycle.

In some embodiments, one or more of the VFDs 411/415/431 and switch 421 can be coupled to be controlled by a suitably programmed computer system, or could be replaced entirely by a dedicated controller configured to run the system 400. All of the running of the various parts (agitation, pumps, separator) can be programmed to run according to pre-set cycles, such that no human operation is required during a resin extraction cycle and every step is automated resulting in higher yields and less labour costs.

An example extraction process will now be described with reference to the system 400 of FIG. 4 and the agitation apparatus 100 of FIG. 1. In operation, approximately equal amounts (by volume) of ice and plant material are loaded into the strainer basket 120 of the agitation apparatus 100/410, such that the basket 120 becomes around ⅓ full. The strainer basket 120 is placed inside of the agitator tank 110 so that the tabs 121 on the top of interior basket fit into their corresponding tabs 111 on the agitator tank 111. The agitation tank 110 is filled with cold water and the agitator (conventional, audio transducer or ultrasonic probe agitators all can be used together or separately) is turned on and set to an appropriate setting using the VFD 411 or other controls.

For a batch wise process the agitation cycle runs for a set time (usually 10-30 minutes) and then turned off. After the agitation cycle, the first pump 414 and vibratory separator apparatus 420 are turned on and water containing plant resin is drained from the agitation apparatus 100/410 into the separator apparatus 420. Once all water has drained into the catchment tank 428 and final product has been collected in the collection vessel 424, the separator apparatus 420 is turned off and water from the catchment tank 428 is pumped by the second pump 430 back into the agitator tank to repeat the cycle. This can be repeated over multiple cycles to extract all resin possible.

For a continuous water flow process, some water is added to the catchment tank 428, and then the vibratory separator apparatus 420 and both pumps 411 and 420 run simultaneously with the agitation apparatus 410. Using the VFDs 415/431, the flow of each pump 414/430 is set to be equal such that the levels of water in the agitation tank 110 and catchment tank 428 stay the same and resin is being constantly extracted in the agitation apparatus 410 and collected in the separator apparatus 420. The cycle is allowed to run for a time appropriate for the plant material being processed, usually 30-90 minutes. Once a cycle is complete the strainer basket 120 can be removed from the agitation tank 110 and spend plant material removed and replaced with new plant material for another cycle. Using multiple interior baskets already filled with plant material and ice lowers downtime and allows greater extraction throughput.

FIG. 4A shows an example screening separator apparatus 440 which may be used instead of the vibratory separator apparatus 420 in the resin extraction system 400 according to another embodiment of the present disclosure. In the embodiment illustrated in FIG. 4A, the screening separator apparatus 440 comprises a plurality of screening canisters 450 mounted on a mounting frame 442. Each canister 450 has an inlet 452 and an outlet 454 as shown in FIG. 4B and discussed further below. Four canisters 450 are shown in the illustrated example, labelled 450A, 450B, 450C, 450D, and are connected in sequence, with the outlets 454 of each of the first, second and third canisters 450A/450B/450C connected by a hose (not shown) to the inlets 452 of each of the second, third and fourth canisters 450B/450C/450D. The inlet 452 of the first canister 450A is connected to the output 416 from the first pump 414, and the outlet 454 of the fourth canister 450C is connected to the water catchment tank 428 (see FIG. 4).

FIG. 4B is a sectional view of one of the canisters 450. Each canister 450 comprises an inlet 452, and outlet 454, and a perforated cylinder 456 disposed therebetween. A sampling port/pressure relief valve 458 is provided in the lid 459 of the canister. The perforated cylinder 456 holds a screening basket (not shown) for trapping product (resin/trichomes) with openings having a size selected based on the placement of the canister 450 in the sequence. The canisters 450 may be substantially identical to one another, with the exception of the size of the openings in the screen, with the first canister 450A having the largest openings, and each successive canister having smaller openings, with the fourth canister 450D having the smallest openings. For example, in some embodiments, the first canister 450A has a screening basket with openings with a diameter in the range of 190-170 microns, the second canister 450B has a screening basket with openings with a diameter of about 120 microns, the third canister 450C has a screening basket with openings with a diameter of about 70 microns, and the fourth canister 450D has a screening basket with openings with a diameter of about 40 microns. In operation, after an agitation cycle as discussed above, the first pump 414 is turned on and water containing plant resin is drained from the agitation apparatus 100/410 into the screening separator apparatus 440, and the water/resin mixture passes through canisters 450A, 450B, 450C, and 450D in sequence. The screening baskets in each canister trap resin/trichomes of successively smaller diameters, and once all of the water/resin mixture has passed through the screening separator apparatus 440, the lids 459 of the canisters 450A, 450B, 450C, and 450D are opened and the screening baskets are removed to collect the resin/trichomes.

In some embodiments, instead of plant material being put into a basket in an agitation tank and removed after each batch, plant material can flow through an agitation apparatus configured to serve as a continuous reaction cell. In some embodiments, plant material in cold water flows through a passageway wherein resin is continuously separated from the plant material. Agitation is applied as plant material flows through the passageway, and trichomes are separated from plant material. Plant material is then extruded from the machine as more enters in a continuous process. Such embodiments may be well suited for large production facilities which have a constant supply of plant material to process.

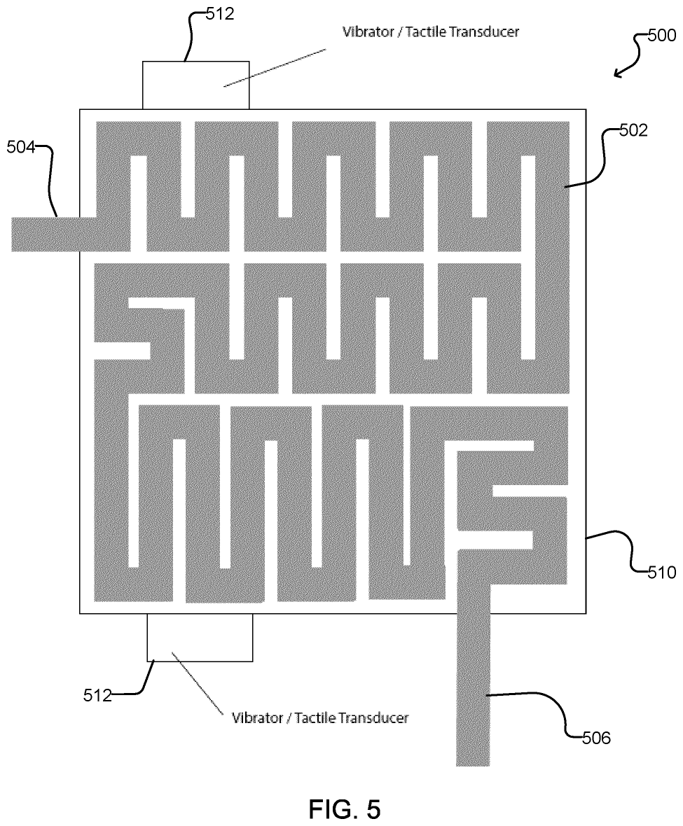

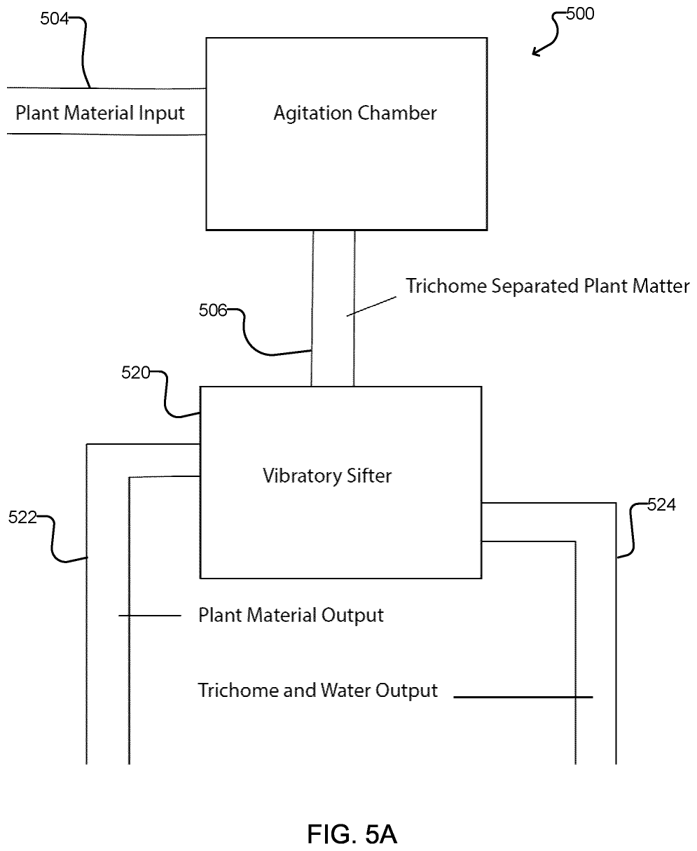

An example agitation apparatus 500 configured for continuous processing of plant material is shown in FIG. 5. The agitation apparatus 500 may take the place of apparatus 410 in the system of FIG. 4 in some embodiments. The apparatus 500 comprises a passageway 502 having an inlet 504 for receiving unprocessed plant material (having trichomes still attached thereto) and cold water, and an outlet for discharging a mixture of water and trichomes, along with processed plant material (from which trichomes have been removed). The passageway 502 has a plurality of abrupt changes in direction between the inlet 504 and the outlet 506. In the FIG. 5 example, the passageway 502 has a plurality of sharp right-angle changes in direction, but in some embodiments the changes in direction may be less than or greater than 90 degrees. In some embodiments the passageway 502 may be formed by a pipe or the like. In the FIG. 5 example, the passageway 502 is largely contained within an agitation chamber 510. Two transducers 512 are coupled to the chamber 510. The transducers 512 may, for example, comprise audio wave transducers such as those described above with reference to FIGS. 1B and 1C. In some embodiments vibratory transducers may instead be coupled directly to the passageway 502. In some embodiments, one or more ultrasonic probes may be inserted into the passageway 502.

In some embodiments, the outlet 506 of the agitation apparatus 500 may be connected to provide the mixture of water and trichomes, along with processed plant material (from which trichomes have been removed), directly to a vibratory separator apparatus such as apparatus 420 of FIG. 4. In such embodiments, the vibratory separator apparatus 420 is configured to separate the processed plant material from the mixture of water and trichomes.

In some embodiments, a filter may be provided downstream of the agitation apparatus 500 to remove processed plant material (from which trichomes have been removed) from the mixture of water and trichomes. FIG. 5A shows an example of such an embodiment wherein the filter is implemented as a vibratory sifter 520. The vibratory sifter 520 is connected to the outlet 506 of the passageway 502, and has a first outlet 522 for discharging the processed plant material, and a second outlet 524 for discharging the mixture of water and trichomes. The second outlet 524 may, for example, be connected directly to the vibratory separator apparatus 420 of FIG. 4.

The present disclosure may be embodied in other specific forms without departing from its spirit or essential characteristics. The described embodiments are to be considered in all respects only as illustrative and not restrictive.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples.

1. An apparatus for extracting resin from plant material, the apparatus comprising:
an agitation tank having an open top and an outlet at a bottom thereof;
a strainer basket installed within the agitation tank, the strainer basket comprising walls constructed from a filtering material selected based on a type of plant material to be processed; and,
an agitator comprising a motor which turns a shaft and having a first impeller and a second impeller mounted on the shaft.

2. The apparatus of claim 1 wherein when the shaft rotates in a first sense the first impeller urges material upwardly and the second impeller urges material downwardly.

3. The apparatus of claim 1 comprising a blade impeller mounted on the shaft for lacerating plant material.

4. The apparatus of claim 3 wherein the blade impeller is mounted on the shaft below the first and second impellers.

5. The apparatus of claim 3 wherein the blade impeller is mounted on the shaft between the first and second impellers.

6. The apparatus of claim 3 wherein a lower one of the first and second impellers comprises the blade impeller.

7. The apparatus of claim 1 wherein the first impeller comprises an upper impeller which urges material downwardly and the second impeller comprises a lower impeller which urges material upwardly.

8. The apparatus of claim 1 wherein both of the two impellers urge material upwardly.

9. The apparatus of claim 1 wherein both of the two impellers urge material downwardly.

10. The apparatus of claim 1 wherein the walls of the strainer basket comprise a mesh having openings with a diameter in a range of 200-230 microns.

11. The apparatus of claim 1 wherein the walls of the strainer basket comprise a plurality of wedge wires separated by gaps in a range of 200-250 microns.

12. The apparatus of claim 1 wherein the strainer basket comprises a plurality of baffles extending inwardly from a sidewall of the strainer basket.

13. The apparatus of claim 12 wherein a side gap separates each baffle from the sidewall, and a bottom gap separates each baffle from a bottom wall of the strainer basket.

14. The apparatus of claim 13 wherein each of the plurality of baffles comprises a rounded baffle having an oval-shaped cross-section.

15. The apparatus of claim 1 wherein the strainer basket is removeable from the agitation tank.

16. The apparatus of claim 15 wherein the strainer basket comprises a plurality of mounting tabs extending outwardly from an upper rim of the strainer basket for suspending the strainer basket within the agitation tank.

17. The apparatus of claim 15 wherein the strainer basket comprises a plurality of draining tabs extending outwardly from a middle portion of the strainer basket for suspending the strainer basket partially out of the agitation tank.

18. A process for extracting resin from plant material, the process comprising:
placing a quantity of plant material within a strainer basket comprising walls constructed from a mesh material;
submersing the strainer basket in a tank filled with chilled water at a temperature in the range of 0-10 Celsius;
agitating the plant material and chilled water within the strainer basket to separate trichomes from the plant material; and
removing a mixture of water and trichomes from an outlet at the bottom of the tank.

19. The process of claim 18 further comprising providing the mixture of water and trichomes to a vibratory separator apparatus to separate the mixture into water a final product containing the trichomes and recycling the separated water back to the tank.

20. The process of claim 18 further comprising providing the mixture of water and trichomes to a screening separator apparatus to separate the mixture into water, a final product containing trichomes and recycling the separated water back to the tank.

21. (canceled)

22. (canceled)

23. (canceled)

24. A system for extracting resin from plant material, the system comprising:
an agitation apparatus for receiving plant material and chilled water, the agitation apparatus configured to agitate the plant material to separate trichomes from the plant material to produce a mixture of water and trichomes;
a separator apparatus connected to receive the mixture of water and trichomes from the agitation apparatus, the separator apparatus configured to separate water from the mixture to produce a final product containing the trichomes;
wherein the agitation apparatus comprises:
an agitation tank having an open top and an outlet at a bottom thereof;
a strainer basket installed within the agitation tank, the strainer basket comprising walls constructed from a mesh material selected based on a type of plant material to be processed; and,
an agitator comprising a motor which turns a shaft and two impellers mounted on the shaft.

25. A system for extracting resin from plant material, the system comprising:
an agitation apparatus for receiving plant material and chilled water, the agitation apparatus configured to agitate the plant material to separate trichomes from the plant material to produce a mixture of water and trichomes;
a separator apparatus connected to receive the mixture of water and trichomes from the agitation apparatus, the separator apparatus configured to separate water from the mixture to produce a final product containing the trichomes;
wherein the agitation apparatus comprises a passageway having an inlet and an outlet and a plurality of abrupt changes in direction between the inlet and the outlet.

26. The system of claim 25 wherein the agitation apparatus comprises an agitation chamber, and the passageway is contained within the agitation chamber.

27. The system of claim 26 wherein the agitation apparatus comprises one or more vibratory transducers coupled to the agitation chamber.

28. The system of claim 27 comprising a filter between the outlet of the passageway and the separator apparatus to filter plant material from the mixture of water and trichomes.

29. The system of claim 27 wherein the separator apparatus is configured to separate plant material from the mixture of water and trichomes.
